(19) United States
(12) Patent Application Publication
(10) Pub. No.: US 2011/0216528 A1
(43) Pub. Date: Sep. 8, 2011

(54) MODULAR DRIVER FOR ILLUMINATION AND HAVING DRIVER HEAD CARTRIDGE

(76) Inventor: Kun-Chih Hung, Ta-Li City (TW)

(21) Appl. No.: 12/718,999

(22) Filed: Mar. 7, 2010

(51) Int. Cl. B25B 23/18; B25B 23/16

(52) U.S. Cl. 362/120; 81/177.4

(57) ABSTRACT

A modular driver for illumination and having a driver head cartridge comprises: a grip; an inner frame disposed within the grip, the rear end of the inner frame being provided with a plurality of recesses, one side at the front end of the inner frame defining an assembly section, the other side defining a battery containing section; a circuit board mounted on the assembly section of the inner frame, an LED lamp, an actuating switch and a power supply pin being integrated on the circuit board; and a rear cap disposed on the end of the grip, the rear cap being provided with a through hole, the rear cap being turned so that the through hole can be disposed with respect to one of the recesses.

### FIELD OF THE INVENTION

The present invention relates to a driver structure, and more particularly to a modular driver for illumination and having a driver head cartridge.

### BACKGROUND OF THE INVENTION

Taiwan patent publication No. 337743 entitled “Tool kit with illumination function” discloses a driver structure for illumination, in which, for the most part, an illumination mechanism comprised of a bulb is filled within its grip so as to achieve the effect of illumination when in use. However, a driver structure comprised of such structure must be used in combination with a larger volume nickel-metal hydride battery to actuate the bulb. This results in the drawback that it is not easy to hold and operate the tool kit because of excessively large volume and heavier weight of the grip.

Moreover, Taiwan patent publication No. M324516 discloses a screwdriver with illumination function, in which a circuit board containing a plurality of light emitting diodes (LEDs) is disposed at the front end of the grip, and a battery holder, a pressing switch and a rear cap are disposed at the rear end of the grip. However, due to the arrangement of the circuit board and the battery holder separately at the front and rear ends of such driver structure, it is more inconvenient to connect the circuit board and the battery holder by additional conducting wires in assembly, and this further results in an increase in manufacturing costs. Furthermore, during replacement of the battery in such driver structure, the batteries must be sequentially placed into the opening on the top of the battery holder. Therefore, a problem that often occurs is that it is more difficult to place the batteries into the battery holder because of their small volume.

In view of the above-described circumstances, how to solve the above-mentioned problems is the most important subject of the present invention. As a result, various considerations and attempts have been made continuously by the inventors to achieve the invention.

### SUMMARY OF THE INVENTION

A first object of the present invention is to provide a modular driver for illumination and having a driver head cartridge, wherein it is most effective to use the space of the grip and thus the total volume of the modular driver of the present invention can be effectively reduced.

A second object of the present invention is to provide a modular driver for illumination and having a driver head cartridge, which has the advantages of simple structure and easy assembly, maintenance and replacement.

A third object of the present invention is to provide a modular driver for illumination and having a driver head cartridge, which has the advantage of easy replacement of the battery.

In order to achieve the foregoing objects, the present invention provides a modular driver for illumination and having a driver head cartridge, comprising:

a grip of a hollow tubular shape, the front end of the grip having a coupling portion for fitting with a driver head, the grip being formed with a connecting portion at its end, at least the front end of the grip being made transparent, a through opening being provided at a position of the grip adjacent to its front end, the through opening being configured for passage of an actuating button;

an inner frame exactly contained within the grip, the rear end of the inner frame being sequentially provided with a plurality of recesses configured for storage of different driver heads, one side at the front end of the inner frame defining an assembly section, the opposite side of the assembly section defining a battery containing section;

a circuit board mounted on the assembly section of the inner frame, an LED lamp, an actuating switch and a power supply pin being integrated on the circuit board, wherein the LED lamp is disposed toward the front end of the grip, the actuating switch and the actuating button are disposed with respect to each other, and the power supply pin runs through the assembly section and is located in the battery containing section; and

a rear cap correspondingly coupled to the connecting portion at the end of the grip, the end surface of the rear cap being provided with a through hole, the rear cap being turned so that the through hole can be disposed with respect to one of the recesses.

The above objects and advantages of the present invention will become apparent from the following detailed description of preferred embodiments of the invention when read in connection with the accompanying drawings.

Of course, the present invention allows different arrangements in some other cases, but the preferred embodiments will be described in detail herein.

### BRIEF DESCRIPTION OF THE DRAWINGS

FIG. 1 is a schematic three-dimensional exploded view showing a structure according to the present invention.

FIG. 2 is a schematic view showing a three-dimensional structure according to the present invention after assembled.

FIG. 3 is a schematic view showing a planar structure according to the present invention after assembled.

FIG. 4 is a cross-sectional view of the present invention after assembled.

FIG. 5 is a schematic view of a usage state of the present invention in order to show the state when the actuating button is pressed to push the actuating switch.

FIG. 6 is a schematic view of a usage state of the present invention in order to show the state when the battery is replaced.

FIG. 7 is a schematic view of a usage state of the present invention in order to show the state when the rear cap is rotated such that the through hole reaches a position with respect to one of the recesses.

### DETAILED DESCRIPTION OF THE PREFERRED EMBODIMENTS

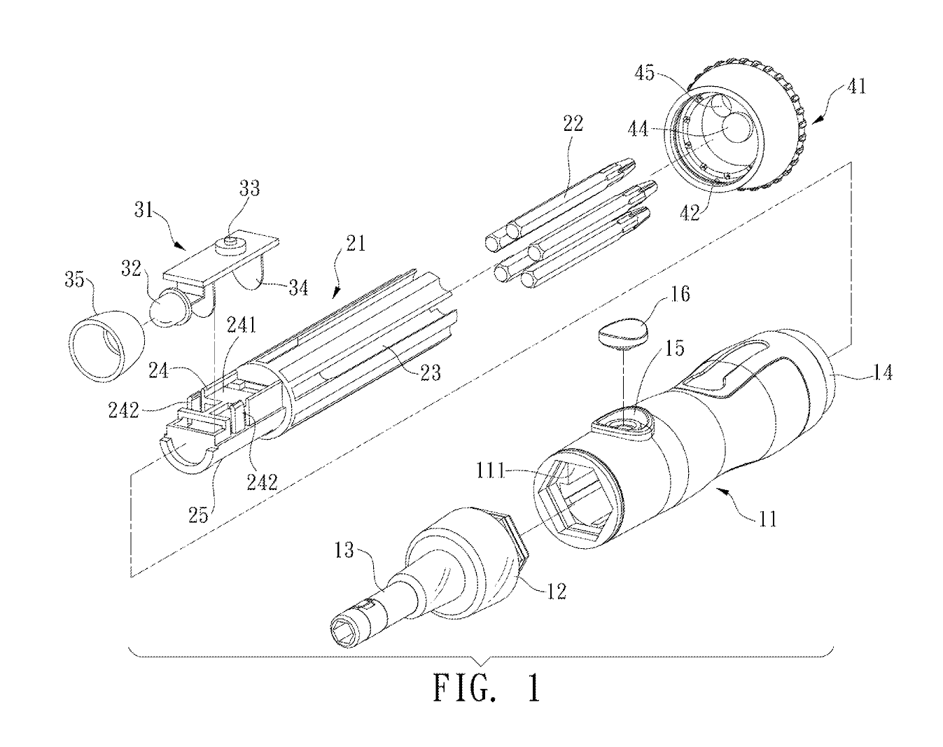

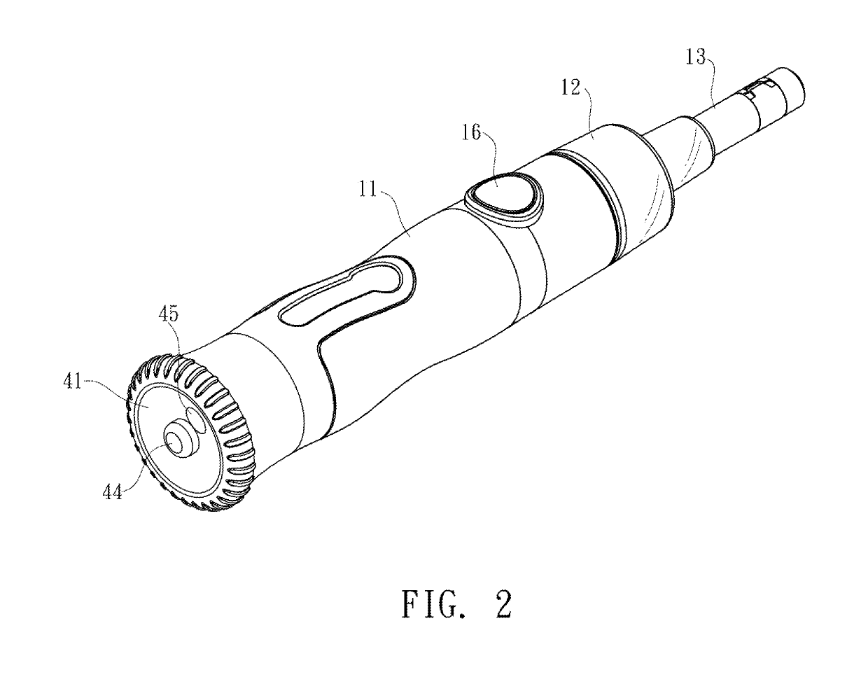

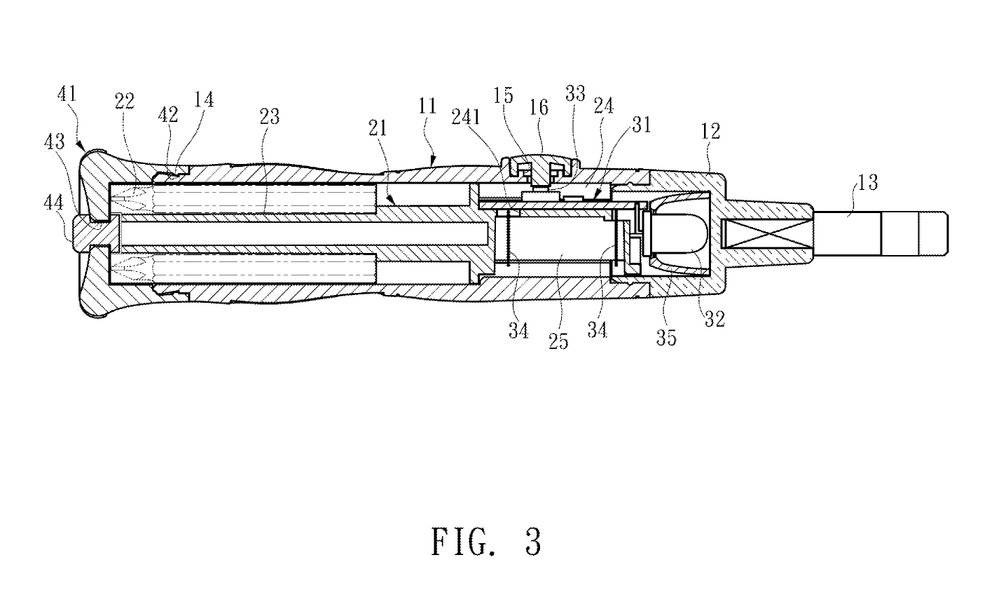

First, referring to FIGS. 1 to 4, there is provided a modular driver for illumination and having a driver head cartridge, which is mainly comprised of a grip 11, an inner frame 21, a circuit board 31 and a rear cap 41.

The grip 11 is of a hollow tubular shape. In this embodiment, the front end of the grip 11 is connected with a transparent shell 12. The front end of the transparent shell 12 is provided with a coupling portion 13 for fitting with a driver head. The grip 11 is formed with a connecting portion 14 at its end. A through opening 15 is provided at a position of the grip 11 adjacent to its front end, and the through opening 15 is configured for passage of an actuating button 16. Furthermore, the grip 11 has two walls 111 arranged parallel with respect to each other formed on the inner edge at the front end thereof.

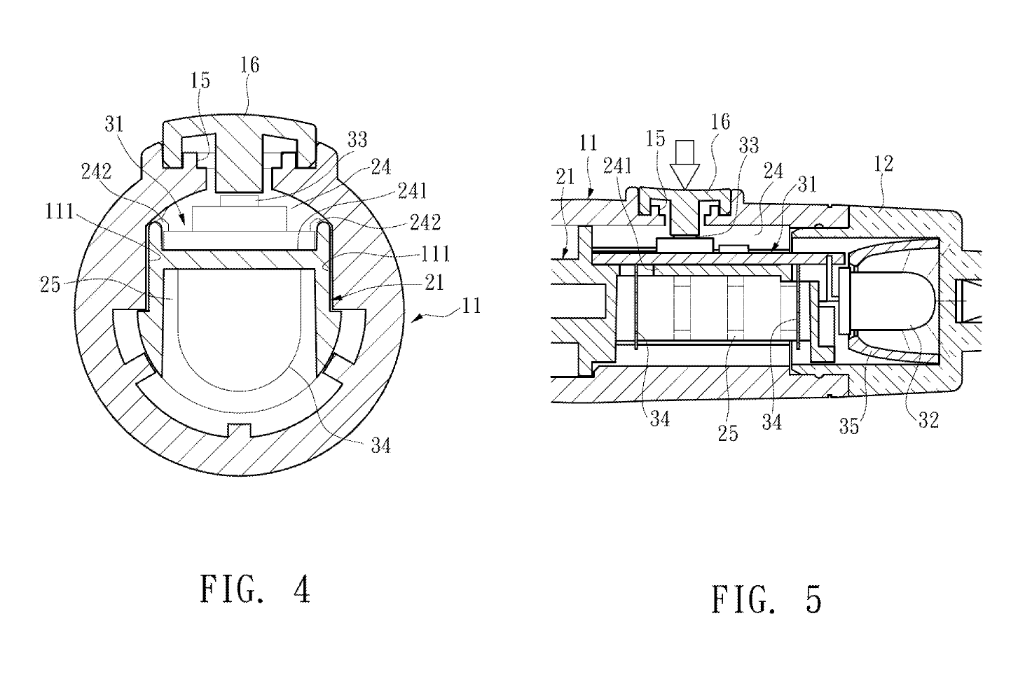

The inner frame 21 is contained within the grip 11. The front end of the inner frame 21 is exactly wedged by the two walls 111 on the inner edge of the grip 11 so as to avoid rotation of the inner frame 21 when contained within the grip 11 (as shown in FIG. 4). The rear end of the inner frame 21 is sequentially concavely provided with a plurality of recesses 23 configured for storage of different driver heads 22. One side at the front end of the inner frame 21 defines an assembly section 24. There is a bracket 241 in the assembly section 24, and each of two sides of the bracket 241 extends to form a clamping arm 242. Furthermore, the opposite side of the assembly section 24 defines a battery containing section 25.

The circuit board 31 is mounted on the bracket 241 in the assembly section 24 at the front end of the inner frame 21, and can be exactly held and positioned on the bracket 241 by the two clamping arms 242. An LED lamp 32, an actuating switch 33 and a power supply pin 34 are integrated on the circuit board 31. The LED lamp 32 is disposed toward the direction of the coupling portion 13 at the front end of the grip 11. The LED lamp 32 is further surrounded by an arc-shaped reflective plate 35. The actuating switch 33 and the actuating button 16 are disposed with respect to each other. The power supply pin 34 runs through the assembly section 24 and is located in the battery containing section 25.

The inner edge of the rear cap 41 is peripherally provided with a clamping portion 42, and the rear cap 41 is correspondingly clamped to the connecting portion 14 at the end of the grip 11 by the clamping portion 42, whereby the end of the grip 11 is closed so as to prevent the disengagement of the inner frame 21 from the grip 11. An axle hole 43 is provided at the center of the end surface of the rear cap 41, and a knob 44 passes through the axle hole 43. A through hole 45 is provided on the rear cap 41 and beside the axle hole 43. When the rear cap 41 is correspondingly clamped to the connecting portion 14 at the end of the grip 11, the grip 11 can be rotated with the rear cap 41 around the knob 44 as an axle center. When the rear cap 91 is turned by force to overcome the clamping force provided by the clamping portion 42 of the rear cap 91, the rear cap 41 can be rotated with respect to the grip 11 so that the through hole 45 can be disposed with respect to one of the recesses 23.

Next, referring to FIG. 5, in practical use of the above-described structure of the present invention, the user presses the actuating button 16 to push the actuating switch 33 on the circuit board 31 such that electric power starts to be supplied to the LED lamp 32 via the circuit board 31 to enable the LED lamp 32 to generate illumination light.

According to the above-described structure of the present invention, the circuit board 31 is mounted at the front end of the inner frame 21, and the LED lamp 32, the actuating switch 33 and the power supply pin 34 are integrated on the circuit board 31, so it is most effective to use the space at the front end of the grip 11. Thus, the total volume of the modular driver of the present invention can be effectively reduced.

Additionally, in the assembly of the modular driver of the present invention, since the LED lamp 32, the actuating switch 33 and the power supply pin 34 have been modularized, it is only necessary to mount the circuit board 31 on the assembly section 24 at the front end of the inner frame 21, followed by directly placing the inner frame 21 on which the circuit board 31 has been mounted into the grip 11, and fitting the transparent shell 12 and the rear cap 41 onto the grip 11 to complete the entire assembling of a driver of the present invention. Therefore, the assembling is very easy and quick.

Furthermore, the LED lamp 32, the actuating switch 33 and the power supply pin 34 are together integrated on the circuit board 31. As a result, during the maintenance, it only needs to take the inner frame 21 out of the grip 11 to directly replace the circuit board 31. This further provides an advantage of easy maintenance.

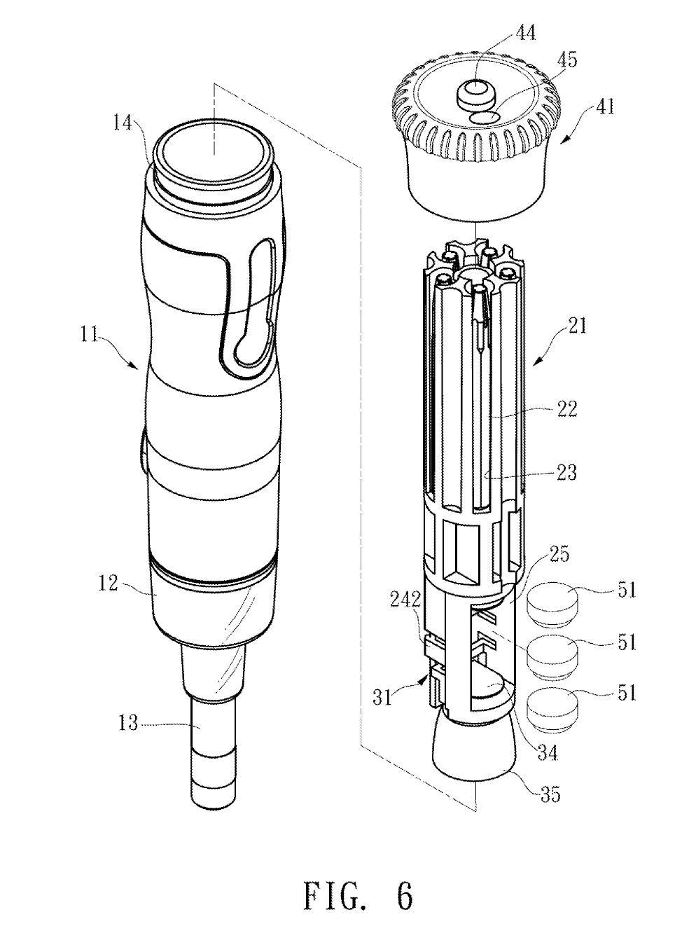

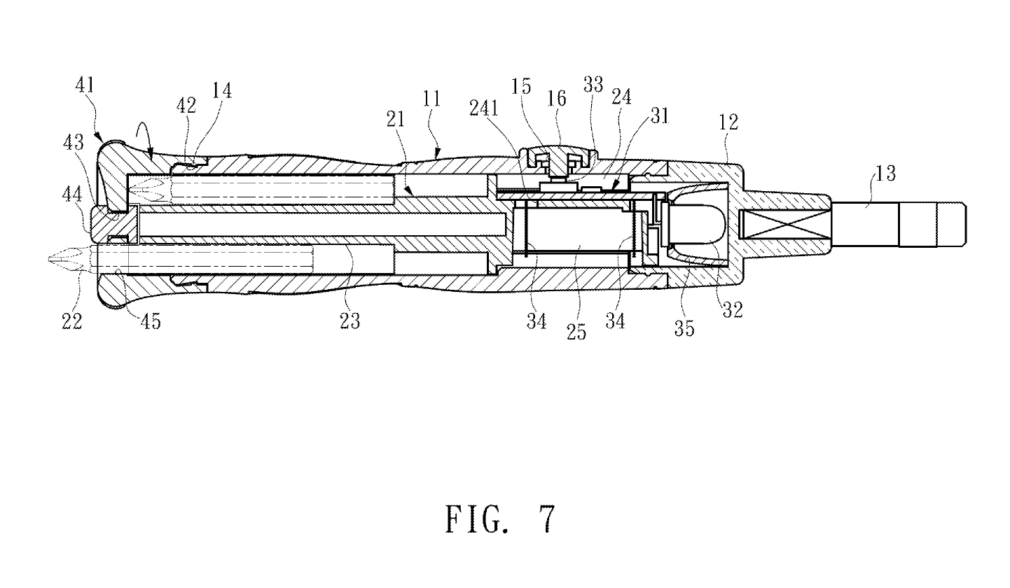

Then, referring to FIG. 6, when replacement of the battery 51 is desired, it only needs to take the inner frame 21 out of the grip 11 so that the battery 51 can be easily taken out of the battery containing section 25 beside the front end of the inner frame 21 and replaced. Moreover, the rear end of the inner frame 21 is provided with recesses 23 configured to accommodate driver heads 22 of different sizes. Therefore, when the user applies force to turn the rear cap 41 to overcome the clamping force provided by the clamping portion 42 of the rear cap 41, the rear cap 41 can be rotated with respect to the grip 11 so that the through hole 45 can reach a position with respect to one of the recesses 23 (as shown in FIG. 7). In such manner, the user simply needs to invert the grip 11 and the driver head 22 in this recess 23 will fall out for use. Thus, the present invention offers increased applicability.

However, it is understood that the disclosure of the above-mentioned embodiments is illustrative only and the invention is not limited to the disclosed embodiments, and therefore all changes in values or substitution by equivalent elements should still be included within the scope of the invention.

What is claimed is:

1. A modular driver for illumination and having a driver head cartridge, comprising:
a grip of a hollow tubular shape, the front end of the grip having a coupling portion for fitting with a driver head, the grip being formed with a connecting portion at the end of the grip, at least the front end of the grip being made transparent, a through opening being provided at a position of the grip adjacent to the front end of the grip, the through opening being configured for passage of an actuating button;
an inner frame exactly contained within the grip, the rear end of the inner frame being sequentially concavely provided with a plurality of recesses configured for storage of different driver heads, one side at the front end of the inner frame defining an assembly section, the opposite side of the assembly section defining a battery containing section;
a circuit board mounted on the assembly section of the inner frame, an LED lamp, an actuating switch and a power supply pin being integrated on the circuit board, wherein the LED lamp is disposed toward the front end of the grip, the actuating switch and the actuating button are disposed with respect to each other, and the power supply pin runs through the assembly section and is located in the battery containing section; and
a rear cap correspondingly coupled to the connecting portion at the end of the grip, the end surface of the rear cap being provided with a through hole, the rear cap being turned so that the through hole is disposed with respect to one of the recesses.

2. The modular driver for illumination and having a driver head cartridge as recited in claim 1, wherein the front end of the grip is further connected with a transparent shell and the coupling portion is disposed at the front end of the transparent shell.

3. The modular driver for illumination and having a driver head cartridge as recited in claim 1, wherein the grip has two walls arranged parallel with respect to each other formed on the inner edge at the front end of the grip, and when the inner frame is contained within the grip, the front end of the inner frame is exactly wedged by the two walls on the inner edge of the grip.

4. The modular driver for illumination and having a driver head cartridge as recited in claim 1, wherein there is a bracket in the assembly section, each of two sides of the bracket extends to form a clamping arm, and the circuit board is mounted on the bracket and is exactly held and positioned on the bracket by the two clamping arms.

5. The modular driver for illumination and having a driver head cartridge as recited in claim 1, wherein the LED lamp is further surrounded by an arc-shaped reflective plate.

6. The modular driver for illumination and having a driver head cartridge as recited in claim 1, wherein the inner edge of the rear cap is peripherally provided with a clamping portion and the rear cap is correspondingly clamped to the connecting portion at the end of the grip by the clamping portion and when the rear cap is turned by force to overcome the clamping force provided by the clamping portion of the rear cap, the rear cap can be rotated with respect to the grip so that the through hole can be disposed with respect to one of the recesses.

7. The modular driver for illumination and having a driver head cartridge as recited in claim 6, wherein an axle hole is provided at the center of the end surface of the rear cap and a knob passes through the axle hole and when the rear cap is correspondingly clamped to the connecting portion at the end of the grip, the grip can be rotated with the rear cap around the knob as an axle center.
